(19) United States
(12) Patent Application Publication
(10) Pub. No.: US 2005/0122946 A1
(43) Pub. Date: Jun. 9, 2005

(54) DHCP pool sharing mechanism in mobile environment

(76) Inventor: Chan Yeon Won, San Jose, CA (US)

Correspondence Address: HAVERSTOCK & OWENS LLP, 162 NORTH WOLFE ROAD, SUNNYVALE, CA, 94086, US

(21) Appl. No.: 10/993,281

(22) Filed: Nov. 18, 2004

Related U.S. Application Data
(60) Provisional application No. 60/523,273, filed on Nov. 18, 2003.

(51) Int. Cl. H04Q 7/00

(52) U.S. Cl. 370/338

(57) ABSTRACT

The present invention provides dynamic pool sharing to allow subnets with DHCP servers to borrow IP addresses when subnet capacity requirements reach preexisting limits and assign the IP addresses to DHCP clients. Specifically, the network relies on adjacent subnets to share IP addresses so DHCP clients coupled to mobile devices remain coupled to a wireless network. A DHCP client requests an IP address. A home subnet requests pool sharing with adjacent subnets and selects a candidate among the adjacent subnets. The home subnet then negotiates the selected candidate with the DHCP client.

### RELATED APPLICATION

This Patent Application claims priority under 35 U.S.C. 119 (e) of the co-pending U.S. Provisional Patent Application, Ser. No. 60/523,273, filed Nov. 18, 2003, and entitled “DHCP POOL SHARING MECHANISM IN MOBILE ENVIRONMENT”. The Provisional Patent Application, Ser. No. 60/523,273, filed Nov. 18, 2003, and entitled “DHCP POOL SHARING MECHANISM IN MOBILE ENVIRONMENT” is also hereby incorporated by reference.

### FIELD OF THE INVENTION

The present invention relates to wireless network technology. More particularly, the present invention relates to a DHCP pool sharing mechanism for allowing subnets to borrow IP addresses from one another and assign the IP addresses to DHCP clients.

### BACKGROUND OF THE INVENTION

IP routing depends on a well-structured hierarchy. Routers interconnect networks and send data from one network to another. Networks can interconnect with other networks and contain subnetworks. Private networks are commonly connected to the Internet through one or more routers (which can also be known as a gateway) so that devices on the private network can communicate with nodes on the Internet.

When a block of information or packet is sent from the Internet, routers will operate only on the first few bits of an IP address and forward the packet to the current network delineated by a router. Each IP address has a four octet format. Typically, humans communicate IP addresses in a dotted decimal format, with each octet written as a decimal integer from other octets by decimal points. Subsequent operate on the next few decimal integers, sending the packet to a subnet, which can be a local area network (LAN). The LAN router will operate on the final decimal integer of the IP address and send the packet to a specific machine. Within a LAN, or a subnet, data is delivered using a physical MAC address assigned to each network interface card (NIC). This is a fixed address tied to an Ethernet card. The Address Resolution Protocol (ARP) maps the IP address to the MAC address. The router follows the ARP and sends out a broadcast message asking for the device associated with the particular IP address to respond with its MAC address. Outside of the subnet, delivery based on the MAC address is not possible since there is no logical relationship to the address number and a device on that network. Data is routed to a next higher subnet. If the destination is that network, the MAC address is resolved and the data is delivered. Therefore, outside of the subnet, the IP address is used for routing. Inside the subnet, the MAC address is used for delivery.

For a situation where there are mobile devices, such as PDAs, mobile telephones, and laptop computers, attached to an access point, the MAC address of the mobile devices is associated with an IP address from within the subnet router IP address space. If a user desires to take the mobile device that is attached to one access point and travel with it so that is attaches to a different access point within the same subnet, all that is necessary is for the new access point to respond to the MAC address of the mobile device that has just entered the communication range for taht new access and for the previous access for that new access and for previous access point to cease responding to that MAC address.

If, however, the mobile device moves from one subnet to another, the mobile device will need to dynamically obtain a new IP address to communicate with the new subnet as is required in traditional IP networks. The mobile device will be required to re-register with the LAN and may be required to re-enter a personal identification number (PIN) or some other password when connecting to a new subnet. Specifically, each mobile device must broadcast an assignment request when initially connecting to a new subnet in the wireless IP network, and in particular, to the subnet of the mobile device within the wireless IP network. Dynamic IP address assignment, as well as general IP address management, occurs through dynamic IP address assignment protocols. For instance, the Dynamic Host Configuration Protocol (DHCP) include a dynamic IP address assignment protocol that controls IP address allocation, including the assignment, distribution, maintenance and release of IP addresses for network hosts within an IP network. However, IP management becomes difficult as users roam across subnets and require new IP addresses. In addition, DHCP servers can run out IP addresses to dole out by excess use of its pool of IP addresses.

What is needed is a system and method of dynamic IP address pool sharing among adjacent subnets to allow a mobile device to remain coupled to a wireless network when subnet capacity requirements exceed preexisting limits.

### SUMMARY OF THE INVENTION

The present invention provides systems and methods that allow mobile devices, such as PDAs, mobile telephones, and laptops to roam seamlessly between subnetworks (hereinafter, “subnets”) of a mobile wireless network and communicate through the network with local mobile devices and/or Internet sites. The present invention provides dynamic pool sharing among and across subnets for “borrowing” IP addresses from one another when subnet capacity requirements reach preexisting limits. When this occurs, a home subnet automatically borrows an IP address from an adjacent subnet and assigns the IP address to a user with a mobile device.

In one embodiment of the present invention, a mobile wireless network is disclosed. The network comprises a plurality of subnets. At least one subnet is coupled to a network router. Each subnet includes a DHCP server and at least one access point, wherein each neighboring subnet shares DHCP pool resources to allow a DHCP client with a mobile device to remain coupled to the wireless network.

In accordance with the present invention, the DHCP servers can share the DHCP pool resources by negotiating as peers amongst themselves. If a home DHCP server of the DHCP client runs out of IP addresses to dole out by excess of its pool, the home DHCP server can request pool sharing to one or more adjacent DHCP servers. The adjacent DHCP servers reply s to the home DHCP server with the candidate IP addresses. The home DHCP server preferably selects one of the candidates from among the adjacent DHCP servers by monitoring the DHCP pool resources of the adjacent DHCP servers. Preferably, the home DHCP server assigns a selected IP address that belongs to an adjacent subnet of the adjacent DHCP server to the DHCP client. Preferably, any DHCP options of the DHCP client can be assigned by the adjacent DHCP server. The subnets can be mobile access routers. Preferably, the at least one access point includes a radio antennae.

In accordance with another embodiment of the present invention, a method of allowing a DHCP client with a mobile device to remain coupled to a mobile wireless network is disclosed. The wireless network includes a plurality of subnets, wherein each subnet includes a DHCP server and at least one access point. The method comprises the steps of: requesting an IP address from the DHCP client to a home subnet; requesting DHCP pool resources from the home subnet to adjacent subnets; replying candidates to share, if any, to the home subnets; and selecting one of the candidates among the adjacent subnets as an elected IP address. The method can further include the step of negotiating the elected IP address with the DHCP client.

In accordance with the present invention, the home subnet preferably sends an ACK candidate to a selected adjacent subnet. The home subnets preferably sends a NAK candidate to a non-selected adjacent subnet. Preferably, the selected adjacent subnet registers its candidate. Preferably, the non-selected adjacent subnet reclaims its candidate from the home subnet. The candidate can comprise pool resources and threshold limits. The candidate is preferably selected according to a margin of the DHCP pool resources.

In accordance with another embodiment of the present invention, a DHCP pool sharing apparatus in a mobile wireless network is disclosed. The apparatus comprises a DHCP client coupled to a mobile device for requesting an IP address; and a home subnet coupled to a home DHCP server for requesting pool sharing with adjacent subnets and selecting a candidate among the adjacent subnets. Each adjacent subnet is coupled to an adjacent DHCP server, wherein the home subnet negotiates the selected candidate with the DHCP client.

In accordance with another embodiment of the present invention, a DHCP pool sharing method in a mobile wireless network is disclosed. The method comprises the steps of: requesting an IP address from a DHCP client coupled to a mobile device; requesting pool sharing by a home subnet coupled to a DHCP server to a plurality of adjacent subnets, each adjacent subnet coupled to an adjacent DHCP server; selecting a candidate from one of the adjacent subnets; and negotiating the selected candidate with the DHCP client.

In accordance with another embodiment of the present invention, a mobile wireless network is disclosed. The network comprises a plurality of subnets arranged in an array of subnets. Each of the subnets has a plurality of neighboring subnets and a plurality of non-neighboring subnets. At least one of the subnets is coupled to a network router and each subnet includes a DHCP server and at least one access point, wherein each neighboring subnet shares DHCP pool resources with one another to allow a DHCP client coupled to a mobile device to remain coupled to the wireless network.

In accordance with another embodiment of the present invention, a mobile wireless network is disclosed. The network comprises a plurality of subnets coupled to a master subnet. The master subnet is coupled to a network router. Each subnet includes a DHCP server and at least one access point, wherein each neighboring subnet shares DHCP pool resources to allow a DHCP client coupled to a mobile device to remain coupled to the wireless network.

### BRIEF DESCRIPTION OF THE SEVERAL VIEWS OF THE DRAWINGS

FIG. 1 is a schematic block diagram of an IP Address Pool Sharing apparatus in a wireless environment, in accordance with one embodiment of the present invention.

FIG. 2 is block diagram of an IP Address Pool Sharing apparatus whereby a home subnet requests IP address sharing from adjacent subnets for assigning and negotiating a selected IP address with a mobile device, using architecture of this invention.

FIG. 3 is a flow chart showing DHCP pool sharing in a wireless environment, in accordance with one embodiment of the present invention.

### DETAILED DESCRIPTION OF THE INVENTION

Reference will now be made in detail to the preferred and alternative embodiments of the invention, examples of which are illustrated in the accompanying drawings. While the invention will be described in conjunction with the specific embodiments, it will be understood that the invention is not limited to these embodiments. On the contrary, the invention covers alternatives, modifications and equivalents, which are included within the spirit and scope of the invention as defined by the appended claims as read in light of this specification. Furthermore, in the following detailed description of the present invention, numerous specific details are set forth to provide a thorough understanding of the present invention. However, it should be noted that the present invention may be practiced without these specific details. In other instances, well known methods, procedures and components have not been described in detail as not to unnecessarily obscure aspects of the present invention.

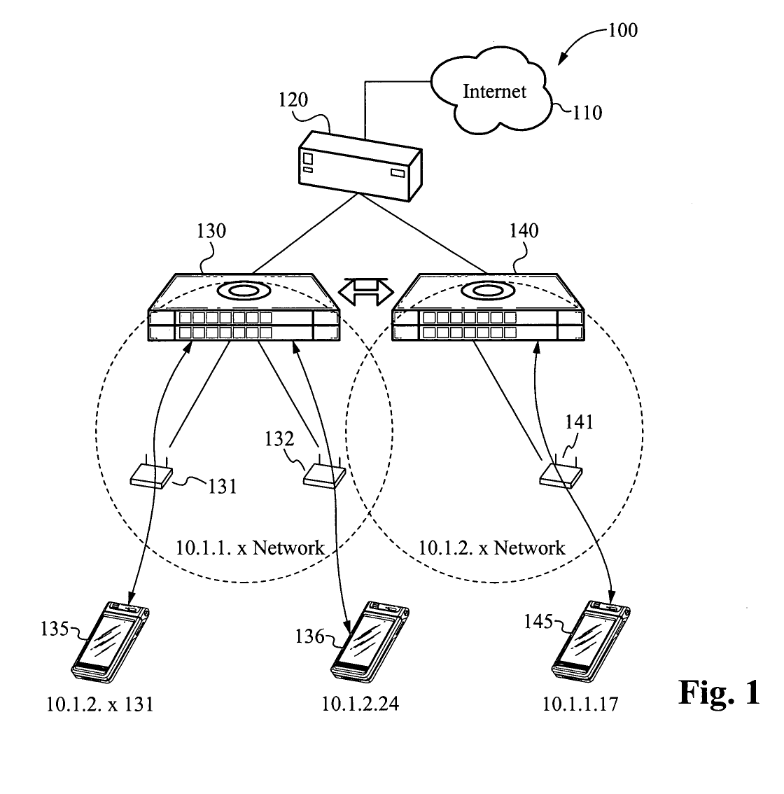

FIG. 1 is a block diagram illustrating an apparatus 100 in which the present invention is implemented. The present invention is implemented in a mobile wireless network. Although the present invention is described as being implemented in a mobile wireless network, the present invention can also be implemented in a fixed wireless network. As shown, a first mobile device 135 (e.g. laptop computer, personal digital assistant (“PDA”) or cellular phone) and a second mobile device 136 are initially based at home subnetwork (subnet) 130 and coupled to access point 131 and 132, respectively. A third mobile device 145 is initially based at adjacent subnet 140 and coupled to access point 141. Although FIG. 1 depicts one access point for each mobile device, each access point can handle many mobile devices within a subnet.

The subnets 130 and 140 serve as routers linked to various access points within each subnet. The subnets 130 and 140 also connect to an Internet router 120 via a communications connection. The Internet router 120, in turn, connects to destinations on the Internet 110 through a communications connection and protocol. In a preferred embodiment of the present invention, each subnet 130 and 140 includes a Dynamic Host Configuration Protocol (DHCP) server which is used to assign TCP/IP settings to DHCP clients. Each mobile device is preferably a DHCP client. The subnets 130 and 140 can simultaneously support 802.11 b/g/a standards, as well as Bluetooth. It should be noted that there can be multiple subnets within the wireless network and each subnet can be coupled for DHCP pool sharing.

In a wireless network, the access points 131, 132 and 141 can have radio antennas and receivers for receiving packets. The access points 131, 132 and 141 also designate connection points in the wireless (or non-wireless) network. According to the present invention, each subnet can manage up to 16 access points to provide roaming and throughput controls. Each access point can handle up to 40 users. Therefore, each subnet connects up to 640 users. While the drawing of FIG. 1 shows only three access points, it will be appreciated that there can be many access points.

Still referring to FIG. 1, assume that mobile device 135 is a DHCP client and has not yet received an IP address. Also assume that the IP domain of the home subnet is 10.1.1.X and the IP domain of the adjacent subnet is 10.1.2.X. The mobile device 135 requests an IP address from the home subnet 130 via a broadcast message to the home subnet 130. If the home subnet 130 cannot satisfy a request for an IP address from its own pool, the home subnet 130 requests to “borrow” an IP address from an adjacent subnet, e.g. the adjacent subnet 140. Thus, if the home subnet 130 is out of IP addresses to dole out to the mobile device 135, the home subnet 130 requests pool sharing with the adjacent subnet 140. As mentioned above, each subnet 130 and 140 is coupled to a DHCP server. The adjacent subnet 140 replies its candidates or available IP addresses to the home subnet 130. The home subnet 130 selects one of the candidates from an adjacent subnet 140. The home subnet 130 then assigns the selected IP address, and any related DHCP options that belong to the adjacent subnet 140, to the mobile device 135. As such, the “new” server of the mobile device 135 becomes the adjacent subnet 140, which leases the IP address, and all DHCP options of the mobile device 135 are assigned by the adjacent subnet 140. The borrowed IP address, in this example, is 10.1.2.131.

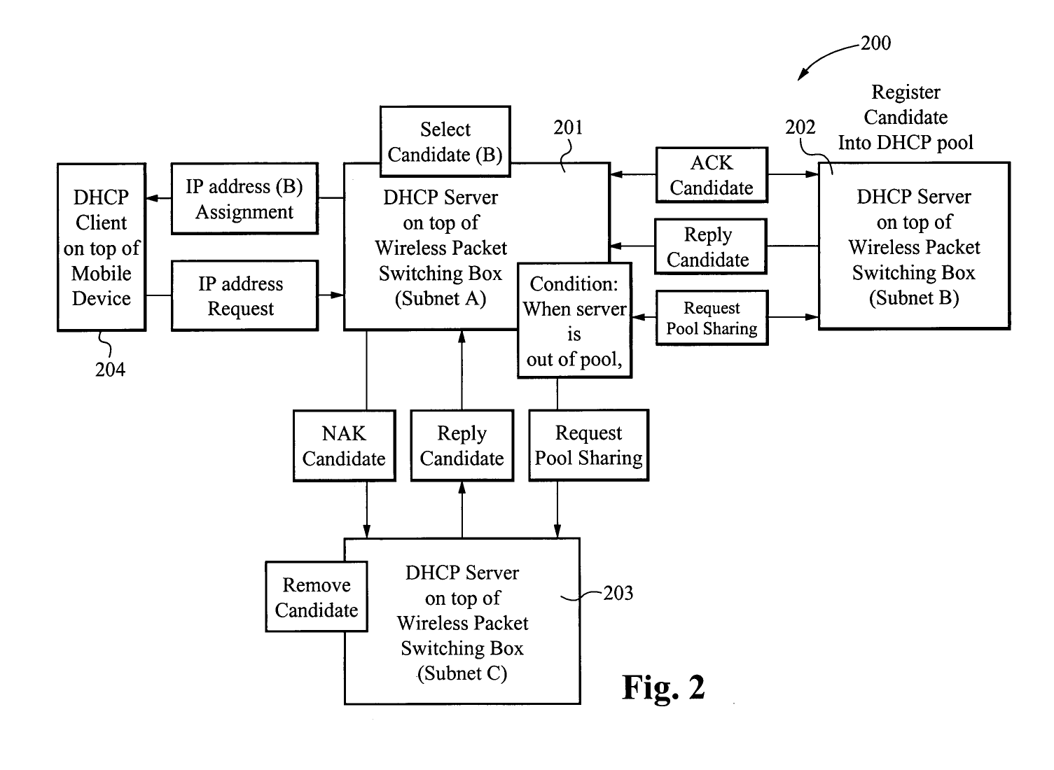

FIG. 2 is block diagram of an IP one or more Address Pool Sharing apparatus 200 whereby a home subnet requests to borrow an IP address sharing from adjacent subnets for assigning and negotiating a selected IP address with a mobile device, using the architecture of this invention. Assume that a DHCP client 204 coupled to a mobile device requests an IP address from Subnet A# 201, which is a home subnet of the DHCP client 201 and is coupled to a DHCP server. If the Subnet A 201 is out of DHCP pool resources (i.e. IP addresses), the Subnet A201 requests DHCP pool sharing with adjacent subnets, e.g. Subnet B 202 and Subnet C 203. The Subnet B 202 is coupled to a DHCP server and the Subnet C 203 is also coupled to a DHCP server. As soon as the adjacent subnets 202 and 203 receive the DHCP pooling request, the subnets 202 and 203 reply with their candidates, of available IP addresses including their pool resources and thresholds, if any, to the Subnet A 201. It is possible that the adjacent subnets 202 and 203 have no resources to share. However, assuming that they do, the Subnet A 201 selects one of the candidates from the adjacent subnets 202 and 203 according to a margin of the DHCP pool resources. When a candidate is selected (in our example, candidate B from the Subnet B 202) the Subnet A 201 negotiates the selected candidate B with the DHCP client 204. At this time, the Subnet A 201 has responsibility for DHCP negotiation until acceptance by the DHCP client 204. The Subnet A 201 then sends an ACK candidate to the Subnet B 202, the subnet of the selected candidate, and a NAK candidate to the Subnet C 203, the subnet of the non-selected candidate. Then, the Subnet B 202 registers the candidate into its DHCP pool. The Subnet C 203 reclaims its candidate from the Subnet A 201. It will be appreciated that there can be more than two adjacent subnets for DHCP pool sharing. Further, there can be many DHCP clients requesting IP addresses. In a preferred embodiment, each subnet 201-203 includes at least one access point. The subnets 201-203 are preferably mobile access routers. The access points can include radio antennaes.

As shown in FIG. 2, each subnet 201-203 can share their DHCP pool resources with one another. Each subnet 201-203 can generate a candidate within its DHCP pool resources. Further, any adjacent subnet can maintain a DHCP client as belonging to its DHCP pool resource.

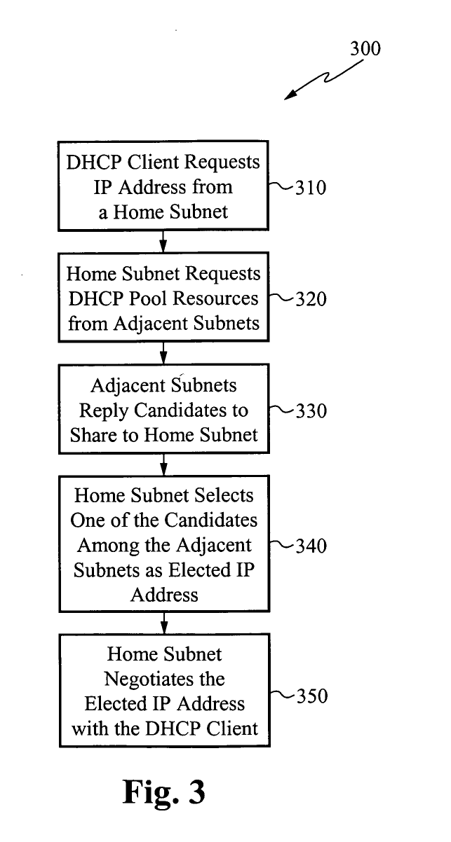

FIG. 3 is a flow chart 300 showing DHCP pool sharing in a wireless environment, in accordance with one embodiment of the present invention. At the step 310, a DHCP client requests an IP address from a home subnet. At step 320, the home subnet requests DHCP pool resources from adjacent subnets. At step 330, the adjacent subnets reply their candidates to share to the home subnet. At step 340, the home subnet selects one of the candidates among the adjacent subnets as an elected IP address. At step 350, the home subnet negotiates the selected IP with the DHCP client.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention.

1. A mobile wireless network, comprising:
a plurality of subnets, at least one subnet coupled to a network router, each subnet including a DHCP server and at least one access point, wherein each neighboring subnet is confirmed to share DHCP pool resources to allow a DHCP client with a mobile device to become coupled to the wireless network. Via a subnet which has more clients than available IP addresses.

2. The mobile wireless network of claim 1 wherein the DHCP servers share the DHCP pool resources by negotiating as peers amongst themselves.

3. The mobile wireless network of claim 2 wherein if a home DHCP server of the DHCP client runs out of IP addresses to dole out by excess of its pool, the home DHCP server requests pool sharing to adjacent DHCP servers.

4. The mobile wireless network of claim 3 wherein the adjacent DHCP servers reply their candidates to the home DHCP server.

5. The mobile wireless network of claim 4 wherein the home DHCP server selects one of the candidates among the adjacent DHCP servers by monitoring the DHCP pool resources of the adjacent DHCP servers.

6. The mobile wireless network of claim 5 wherein the home DHCP server assigns a selected IP address that belongs to an adjacent subnet of the adjacent DHCP server to the DHCP client.

7. The mobile wireless network of claim 6 wherein any DHCP options of the DHCP client are assigned by the adjacent DHCP server.

8. The mobile wireless network of claim 1 wherein the subnets are mobile access routers.

9. The mobile wireless network of claim 1 wherein the at least one access point includes a radio antennae.

10. A method of allowing a DHCP client with a mobile device to remain coupled to a mobile wireless network, the wireless network including a plurality of subnets, each subnet including a DHCP server and at least one access point, the method comprising the steps of:
a. requesting an IP address from the DHCP client to a home subnet;
b. requesting DHCP pool resources by the home subnet to adjacent subnets;
c. replying candidates to share, if any, by one or more of the adjacent subnets to the home subnet; and
d. selecting one of the candidates among the candidates as an elected IP address.

11. The method of claim 10 further comprising the step of negotiating the elected IP address with the DHCP client.

12. The method of claim 10 wherein the home subnet sends an ACK candidate to a selected adjacent subnet.

13. The method of claim 10 wherein the home subnet sends a NAK candidate to a non-selected adjacent subnet.

14. The method of claim 12 wherein the selected adjacent subnet registers its candidate.

15. The method of claim 13 wherein the non-selected adjacent subnet reclaims its candidate from the home subnet.

16. The method of claim 10 wherein the candidate comprises pool resources and threshold limits.

17. The method of claim 10 wherein the candidate is selected according to a margin of the DHCP pool resources.

18. A DHCP pool sharing apparatus in a mobile wireless network, comprising:
a. a DHCP client coupled to a mobile device for requesting an IP address; and
b. a home subnet coupled to a home DHCP server for requesting pool sharing with adjacent subnets, each adjacent subnet coupled to an adjacent DHCP server, and selecting a candidate among the adjacent subnets;
wherein the home subnet negotiates the selected candidate with the DHCP client.

19. The apparatus of claim 18 wherein the home subnet is configured to send an ACK candidate to a selected adjacent subnet.

20. The apparatus of claim 18 wherein the home subnet is configured to send a NAK candidate to a non-selected adjacent subnet.

21. The apparatus of claim 19 wherein the selected adjacent subnet includes means for registering its candidate.

22. The apparatus of claim 20 wherein the non-selected adjacent subnet includes means for reclaiming its candidate from the home subnet.

23. The apparatus of claim 18 wherein the candidate comprises pool resources and threshold limits.

24. The apparatus of claim 18 including means for selecting the candidate is selected according to a margin of the DHCP pool resources.

25. The apparatus of claim 18 wherein the subnets are mobile access routers.

26. The apparatus of claim 18 wherein the at least one access point includes a radio antennae.

27. A DHCP pool sharing method in a mobile wireless network, the method comprising the steps of:
a. requesting an IP address from a DHCP client coupled to a mobile device;
b. requesting pool sharing from a home subnet coupled to a DHCP server to a plurality of adjacent subnets, each adjacent subnet coupled to an adjacent DHCP server;
c. selecting a candidate from one of the adjacent subnets; and
d. negotiating the selected candidate with the DHCP client.

28. The method of claim 27 wherein the home subnet sends an ACK candidate to a selected adjacent subnet.

29. The method of claim 27 wherein the home subnet sends a NAK candidate to a non-selected adjacent subnet.

30. The method of claim 28 wherein the selected adjacent subnet registers its candidate.

31. The method of claim 29 wherein the non-selected adjacent subnet reclaims its candidate from the home subnet.

32. The method of claim 27 wherein the candidate comprises pool resources and threshold limits.

33. The method of claim 27 wherein the candidate is selected according to a margin of the DHCP pool resources.

34. A mobile wireless network, comprising:
a plurality of subnets arranged in an array of subnets, such that each of the subnets has a plurality of neighboring subnets and a plurality of non-neighboring subnets, at least one of the subnets coupled to a network router, each subnet including a DHCP server and at least one access point, wherein each neighboring subnet shares DHCP pool resources with one another to allow a DHCP client coupled to a mobile device to remain coupled to the wireless network.

35. The mobile wireless network of claim 34 wherein the DHCP servers share the DHCP pool resources by negotiating amongst themselves.

36. The mobile wireless network of claim 35 wherein if a home DHCP server of the DHCP client runs out of IP addresses to dole out by excess of its pool, the home DHCP server requests pool sharing to adjacent DHCP servers.

37. The mobile wireless network of claim 36 wherein the adjacent DHCP servers reply their candidates to the home DHCP server.

38. The mobile wireless network of claim 37 wherein the home DHCP server selects one of the candidates among the adjacent DHCP servers by monitoring the DHCP pool resources of the adjacent servers.

39. The mobile wireless network of claim 38 wherein the home DHCP server assigns a selected IP address that belongs to an adjacent subnet of the adjacent DHCP server to the DHCP client.

40. The mobile wireless network of claim 39 wherein any DHCP options of the DHCP client are assigned by the adjacent DHCP server.

41. The mobile wireless network of claim 34 wherein the subnets are mobile access routers.

42. The mobile wireless network of claim 34 wherein the at least one access point is a radio antennae.

43. A mobile wireless network, comprising:
a plurality of subnets coupled to a master subnet, the master subnet coupled to a network router, each subnet including a DHCP server and at least one access point, wherein each neighboring subnet shares DHCP pool resources to allow a DHCP client coupled to a mobile device to remain coupled to the wireless network.

44. The mobile wireless network of claim 43 wherein the DHCP servers share the DHCP pool resources by negotiating amongst themselves.

45. The mobile wireless network of claim 44 wherein if a home DHCP server of the DHCP client runs out of IP addresses to dole out by excess of its pool, the home DHCP server requests pool sharing to adjacent DHCP servers.

46. The mobile wireless network of claim 45 wherein the adjacent DHCP servers reply their candidates to the home DHCP server.

47. The mobile wireless network of claim 46 wherein the home DHCP server selects one of the candidates among the adjacent DHCP servers by monitoring the DHCP pool resources of the adjacent DHCP servers.

48. The mobile wireless network of claim 47 wherein the home DHCP server assigns a selected IP address that belongs to an adjacent subnet of the adjacent DHCP server to the DHCP client.

49. The mobile wireless network of claim 48 wherein any DHCP options of the DHCP client are assigned by the adjacent DHCP server.

50. The mobile wireless network of claim 43 wherein the subnets are mobile access routers.

51. The mobile wireless network of claim 43 wherein the at least one access point is a radio antennae.
